(19) United States
(12) Patent Application Publication
(10) Pub. No.: US 2019/0090119 A1
(43) Pub. Date: Mar. 21, 2019

(54) SYSTEMS, APPARATUS, AND METHODS FOR VARIABLE ADVERTISING

(71) Applicant: QUALCOMM Incorporated, San Diego, CA (US)

(72) Inventors: Robert Scott BALLAM, Eatons Hill (AU); Robert GANTON, San Diego, CA (US)

(21) Appl. No.: 15/839,843

(22) Filed: Dec. 12, 2017

Related U.S. Application Data
(60) Provisional application No. 62/560,136, filed on Sep. 18, 2017.

(51) Int. Cl. H04W 8/00; H04W 4/00

(52) U.S. Cl. CPC H04W 8/005; H04W 4/008

(57) ABSTRACT

Some examples of the disclosure include a Bluetooth Low Energy controller that includes a temperature sensor. The temperature sensor can be monitored periodically to determine the ambient temperature. When the ambient temperature reaches a temperature threshold or lower that impacts battery performance, the operation of the mobile device may be restricted by increasing the advertising interval or stopping advertising and configuring the mobile device to operate in a low power state until the ambient temperature exceeds the temperature threshold. In this way, the advertisement intervals would be dependent on the ambient temperature of the device.

### CROSS-REFERENCE TO RELATED APPLICATIONS

The present application for patent claims the benefit of U.S. Provisional Application No. 62/560,136, entitled “SYSTEMS, APPARATUS, AND METHODS FOR VARIABLE ADVERTISING”, filed Sep. 18, 2017, assigned to the assignee hereof, and expressly incorporated herein by reference in its entirety.

### FIELD OF DISCLOSURE

This disclosure relates generally to wireless status advertising, and more specifically, but not exclusively, to variable advertising for Bluetooth Low Energy devices.

### BACKGROUND

Bluetooth Low Energy (BLE) products which continuously advertise while running off of a small limited capacity battery can run into battery capacity and ESR limitations when the product is exposed to low temperatures. Such products do not limit or stop BLE advertising and microcontroller operation when exposed to low temperatures in order to keep the device from depleting its battery capacity or reset due to high equivalent series resistance (ESR) in the battery circuit or other circuits in the BLE product. A higher ESR can cause a significant drop in output voltage as load current increases and may not be acceptable in some systems. Hence, ESR may significantly decrease battery life and operational efficiency. Accordingly, there is a need for systems, apparatus, and methods that overcome the deficiencies of conventional approaches including the methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a method includes initializing a mobile device configured to use a Bluetooth protocol for communication; setting an advertising interval to a first interval, the advertising interval configured to set a time period for transmitting an advertising packet; periodically transmitting the advertising packet at the first interval; monitoring a temperature, by a temperature sensor, of an environment surrounding the mobile device; setting the advertising interval to a second interval when the temperature reaches a first threshold or lower; and transmitting the advertising packet at the second interval

In another aspect, a non-transitory computer-readable medium comprising instructions that when executed by a processor cause the processor to perform a method comprising: initializing a mobile device configured to use a Bluetooth protocol for communication; setting an advertising interval to a first interval, the advertising interval configured to set a time period for transmitting an advertising packet; periodically transmitting the advertising packet at the first interval; monitoring a temperature, by a temperature sensor, of an environment surrounding the mobile device; setting the advertising interval to a second interval when the temperature reaches a first threshold or lower; and transmitting the advertising packet at the second interval.

In still another aspect, a mobile device includes: a memory; a processor coupled to the memory; a temperature sensor coupled to the processor; the processor configured to: initialize the mobile device, the mobile device configured to use a Bluetooth protocol for communication; set an advertising interval to a first interval, the advertising interval configured to set a time period for transmitting an advertising packet; periodically transmit the advertising packet at the first interval; monitor a temperature, by the temperature sensor, of an environment surrounding the mobile device; set the advertising interval to a second interval when the temperature reaches a first threshold or lower; and transmit the advertising packet at the second interval.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary mobile device transmitting advertising packets in accordance with some examples of the disclosure.

FIG. 2 illustrates an exemplary advertising packet in accordance with some examples of the disclosure.

FIG. 3 illustrates an exemplary partial method of varying an advertising interval in accordance with some examples of the disclosure.

FIG. 4 illustrates an exemplary mobile device in accordance with some examples of the disclosure.

FIG. 5 illustrates various electronic devices that may be integrated with any of the devices and method disclosed herein in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein mitigate shortcomings of the conventional methods, apparatus, and systems, as well as other previously unidentified needs. For example, a BLE controller may include an integrated temperature sensor. This temperature sensor can be monitored periodically to determine the ambient temperature. BLE devices that use coin cells or similar limited capacity batteries suffer from lower capacity and high ESR if the ambient temperature goes below 0 C. The BLE device performance may be improved by monitoring the ambient temperature and using this information to restrict operation of the device when the temperature is low enough to impact battery performance. In one example of a BLE device, such as a package tracker, when the package tracker is activated, it will advertise every few seconds allowing the courier to easily scan for active packages in their vicinity. If a package were to continuously advertise every few seconds when the temperature drops below 0 C as is likely the case in certain shipping environments, then the battery could get depleted very rapidly and it is possible that it would not last until the package gets delivered. In some examples of the disclosure, a BLE device monitors the temperature and when the ambient temperature goes below 0 C, or a programmable temperature level, the advertising interval can be reduced to only a few times per minute. If the temperature falls further to −20 C or lower, then BLE advertisements can be stopped completely and the controller kept in a low power state that only keeps track of time and temperature until the ambient temperature is again within the operational range. In this way, BLE advertisement intervals would be dependent on the ambient temperature of the device.

The temperature thresholds may be configured to include a hysteresis effect at the temperature switch points in order to keep a device from continually changing advertising intervals as the temperature momentarily reaches a switch point but drops below or goes above before reversing direction. For example, the temperature drops to 0 C for a few seconds then goes back above 0 C. Using a hysteresis effect or function, the device may be prevented from changing the advertising interval back and forth due to momentary fluctuations in the temperature. In one example, the temperature may be monitored so that the temperature must fall below the threshold (e.g., 0 C) for more than 10 seconds before the device will switch the advertising interval. In another example, the hysteresis effect may be implemented by requiring more than crossing the temperature threshold by a fraction of a degree such that the BLE radio may be programmed to go from a high advertising rate to a lower rate at 0 C. Once it is in the lower advertising rate it will not switch back to the higher rate until the temperature rises above 1 C (or some other temperature high enough above 0 C to prevent continuous switching). This would ensure that the device will not continuously be changing advertising intervals if there is some noise on the temperature sensor reading and the temperature is hovering around a switch point. The time or temperature ranges for the hysteresis effect may be programmable for a desired lag/range.

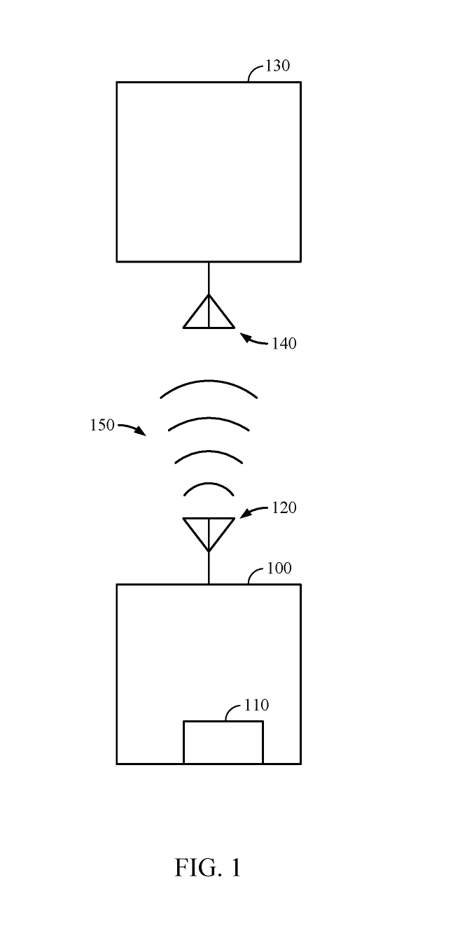

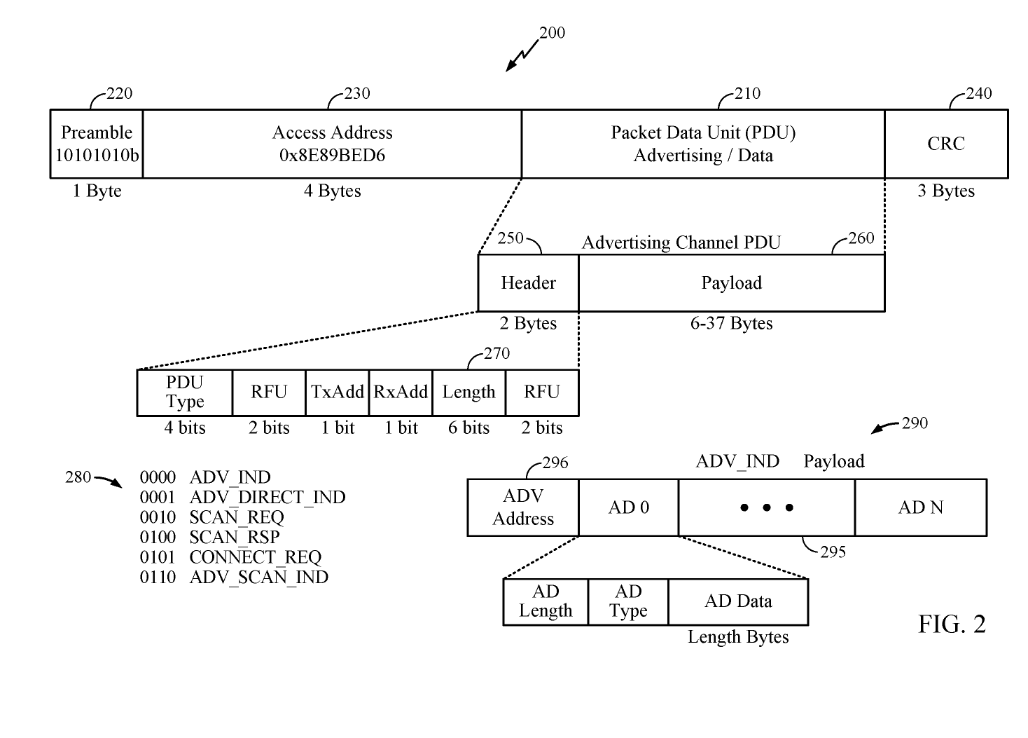

FIG. 1 illustrates an exemplary mobile device transmitting advertising packets in accordance with some examples of the disclosure. As shown in FIG. 1, a first mobile device 100 may include a temperature sensor 110 integrated into or coupled to the first mobile device 100 and an antenna 120 integrated into or coupled to the first mobile device 100. The first mobile device 100 may be configured to periodically transmit advertising packets (e.g., advertising packet 200 in FIG. 2) wirelessly using a Bluetooth protocol and the antenna 120 over a medium 150, such as air, to a second device 130. The second device 130 may be another mobile device or a stationary device and may include an antenna 140 configured to receive the advertising packets transmitted by the first mobile device 100.

The first mobile device 100 may be configured to use a Bluetooth protocol for communication, such as Bluetooth Low Energy protocol. The first mobile device 100 may be configured to set an advertising interval to a first interval, the advertising interval configured to set a time period for transmitting an advertising packet (e.g., advertising packet 200) using antenna 120. The first mobile device 100 may be configured to periodically transmit the advertising packet at the first interval using antenna 120. The first mobile device 100 may be configured to monitor a temperature using the temperature sensor 110 of an environment surrounding the first mobile device 100 (e.g., ambient temperature). The first mobile device 100 may be configured to set the advertising interval to a second interval when the temperature reaches a first threshold or lower. After setting the advertising interval to the second advertising interval, the first mobile device 100 may be configured to transmit the advertising packet at the second interval. The first mobile device 100 may be configured to set the second interval longer than the first interval and set the first threshold to 0 C or other programmable temperature at which battery efficiency may be impacted. The first interval may be a fixed delay of approximately 10 milliseconds to 10.24 seconds plus a random delay of approximately 0 milliseconds to 10 milliseconds. The second interval may set to 11 seconds or longer. The first mobile device 100 may be configured to set the advertising interval to a third interval when the temperature reaches a second threshold or lower where the third interval is longer than the second interval. The third interval may be one minute or longer, for example. Alternatively, the first mobile device 100 may be configured to stop transmission of the advertising packet and configure the first mobile device 100 to operate in a low power state when the temperature reaches a second threshold or lower. The second threshold may be −20 C or other programmable temperature at which battery efficiency may be drastically impacted. The first mobile device 100 may be configured to set the advertising interval from the second interval to the first interval when the temperature exceeds the first threshold, set the advertising interval from the third interval to the second interval when the temperature exceeds the third threshold but not the second threshold, and set the advertising interval from third interval to the first interval when the temperature exceeds the third threshold and the second threshold.

As mentioned above, the first mobile device 100 may be configured to use the Bluetooth Low Energy protocol and implement the BLE advertising service (see, for example, the Bluetooth specification 4.2). The BLE advertising is one of the most important aspects of Bluetooth Low Energy and may help lower the power consumption, speed up connections, and improve reliability. BLE has two ways of communicating. The first one is using advertisements, where a BLE enabled device broadcasts packets to every device around it. The receiving device can then act on this information or connect to receive more information. The second way to communicate is to receive packets using a connection, where both the sending device and the connected device both send packets. A connection may be used to transmit information to another device only or establish a connection between two devices using advertisements. A BLE device sleeps most of the time, waking up only to advertise and connect when needed. This means advertisements have a big impact on power consumption. The advertising interval may be critical in conserving battery power and making quick connections. Advertising is by design unidirectional. A single BLE enable device may advertise to multiple devices in the area. BLE enabled devices may include a BLE Physical Layer. The BLE Physical Layer is in charge of actually sending the signals over the air. This includes the actual RF radio frequency (RF) antenna.

As mentioned above, the temperature thresholds may be configured to include a hysteresis effect at the temperature switch points (e.g., the first threshold and the second threshold) in order to keep the first mobile device 100 from continually changing advertising intervals as the ambient temperature momentarily reaches a switch point but drops below or goes above before reversing direction. For example, the temperature drops to 0 C for a few seconds then goes back above 0 C. Using a hysteresis effect or function, the first mobile device 100 may be prevented from changing the advertising interval back and forth due to momentary fluctuations in the ambient temperature. In one example, the temperature may be monitored so that the temperature must fall below the first threshold (e.g., 0 C) for more than 10 seconds before the first mobile device 100 will switch the advertising interval from the first interval to the second interval. In another example, the hysteresis effect may be implemented by requiring more than crossing the temperature threshold by a fraction of a degree such that the first mobile device 100 may be programmed to go from the first interval to the second interval at the first threshold of 0 C. Once it is in the second interval advertising rate it will not switch back to the first interval until the temperature rises above 1 C (or some other temperature high enough above 0 C to prevent continuous switching). This would ensure that the first mobile device 100 will not continuously be changing advertising intervals if there is some noise on the temperature sensor 110 reading and the temperature is hovering around the first or second threshold. The time or temperature ranges for the hysteresis effect may be programmable for a desired lag/range.

BLE shares some similarities with Classic Bluetooth. Both use the 2.4 GHz spectrum. Basic Rate (BR) and BLE both use Gaussian frequency shift keying (GFSK) modulation at 1 Mbps, but their modulation index is different. Enhanced Data Rate (EDR) uses a completely different modulation than GFSK. Classic Bluetooth has 79 channels compared to BLE's 40 channels. The channels are also spaced differently. Both of these differences make BLE and Classic Bluetooth different and incompatible, so they cannot communicate. The first mobile device 100 may also be configured with Dual Mode Radios that support both BLE and Classic Bluetooth by switching their modulation parameters and the channels on which the mobile device 100 is running. The 2.4 GHz spectrum for Classic Bluetooth extends from 2402 MHz to 2480 MHz while BLE uses 40 1 MHz wide channels, numbered 0 to 39. Each is separated by 2 MHz Channels 37, 38, and 39 are typically used only for sending advertisement packets. The rest are used for data exchange during a connection.

During BLE advertisement, the first mobile device 100 may transmit packets on the 3 advertising channels one after the other. The second device 130 may scan for devices or beacons and listen to those channels for the advertising packets, which helps it discover devices nearby. Channels 37, 38 and 39 may be spread across the 2.4 GHz spectrum with channels 37 and 39 being the first and last channels in the band, while 38 is in the middle. If any single advertising channel is blocked, the other channels are likely to be free since they are separated by quite a few MHz of bandwidth. This is especially true since most other devices that interfere with BLE are narrow band. Channel 38 in particular was placed between Wi-Fi channels 1 and 6 so it avoids the Wi-Fi signal. The wide spacing of the advertisement channels helps BLE better manage the interference from Wi-Fi, Classic Bluetooth, Microwaves, Baby Monitors, etc. to ensure that advertisements succeed.

When the first mobile device 100 is in advertising mode, advertising packets may be sent periodically on each advertising channel. The time interval between packets may have both a fixed interval and a random delay. The first mobile device 100 may set the fixed interval from 20 milliseconds to 10.24 seconds, in steps of 0.625 milliseconds, for example. The random delay may be a pseudo-random value from 0 milliseconds to 10 milliseconds that is automatically added. This randomness helps reduce the possibility of collisions between advertisements of different devices. Since finding advertisements may be critical, avoiding collisions at all costs may be extremely important. Alternatively, the first mobile device 100 may be configured to advertise on just one or two channels, not all three to save power. The advertising interval may be separate from the connection interval to avoid interference.

FIG. 2 illustrates an exemplary advertising packet in accordance with some examples of the disclosure. As shown in FIG. 2, an advertising packet 200 may include two data units, such as a packet data unit (PDU) 210, or one as shown. The advertising packet 200 may also include a preamble 220, an access address 230, and a Cyclic Redundancy Code (CRC) 240. The packet data unit (PDU) 210 for the advertising channel (some time called the Advertising Channel PDU) may include a 2-byte header 250 and a variable payload 260 from 6 to 37 bytes. The actual length of the variable payload 260 may be defined by the 6-bit Length field 270 in the header 250 of the PDU 210. Several PDU types 280 for the advertisements may be used although FIG. 2 shows an exemplary ADV_IND 290. ADV_IND 290 may be a generic advertisement since it is not directed and it is connectable, meaning that the second device 130 may connect to the first mobile device 100 that is advertising, and it is not directed towards a particular device.

The PDU 210 may be configured to provide information to the second device 130, such as package information in a package tracking application. The PDU 210 may have a variable payload 260 that contains the information. FIG. 2 shows ADV_IND payload 295 that may contain the desired information. This ADV_IND payload 295 may have an advertisement address 296 of 6 bytes and a variable number of advertisement data structures.

After the advertisement address 296, which may be referred to as the Bluetooth MAC Address although that may change at will, the ADV_IND 290 is left with 37−6=31 bytes for actual advertisement data structures. These may to fit a length, type, and data as desired. At the lowest level, the advertisement has 31 bytes that can advertise any number of different things and each data type may specify a different standard of data in the ADV_IND payload 295. Since the number of advertising data structures is variable, they may be combined as needed to advertise the desired information to the second device 130.

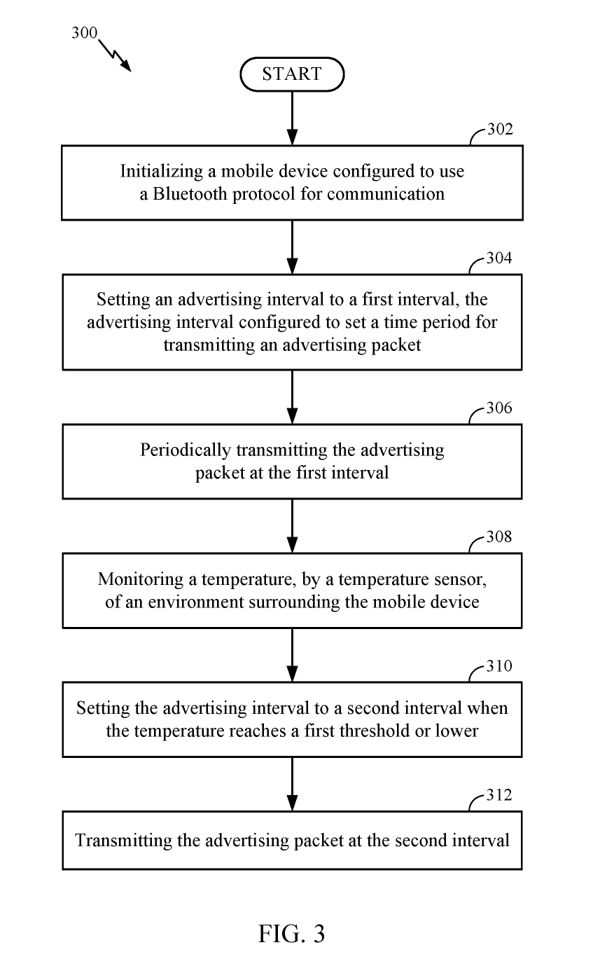

FIG. 3 illustrates an exemplary partial method of varying an advertising interval in accordance with some examples of the disclosure. As shown in FIG. 3, the partial process 300 begins in block 302 with initializing a mobile device (e.g., first mobile device 100, mobile device 400, and integrated device 500) configured to use a Bluetooth protocol for communication. The partial process 300 continues in block 304 with setting an advertising interval to a first interval, the advertising interval configured to set a time period for transmitting an advertising packet (e.g., advertising packet 200). The partial process 300 continues in block 306 with periodically transmitting the advertising packet at the first interval. The partial process 300 continues in block 308 with monitoring a temperature, by a temperature sensor (e.g., temperature sensor 110 and temperature sensor 450), of an environment surrounding the mobile device. The partial process 300 continues in block 310 with setting the advertising interval to a second interval when the temperature reaches a first threshold or lower. The partial process 300 concludes in block 312 with transmitting the advertising packet at the second interval. The partial process 300 may also include setting the second interval longer than the first interval, setting the first threshold to 0 C; setting the first interval to a fixed delay of approximately 10 millisecond to 10.24 seconds plus a random delay of approximately 0 milliseconds to 10 milliseconds; setting the advertising interval to a third interval when the temperature reaches a second threshold or lower; setting the third interval to longer than the second interval; stopping transmission of the advertising packet and configuring the mobile device to operate in a low power state when the temperature reaches a second threshold or lower; setting the advertising interval from the second interval to the first interval when the temperature exceeds the first threshold; setting the advertising interval from the third interval to the second interval when the temperature exceeds the third threshold but not the second threshold; and setting the advertising interval from third interval to the first interval when the temperature exceeds the third threshold and the second threshold.

As mentioned above, in the partial process 300, the temperature thresholds may be configured to include a hysteresis effect at the temperature switch points (e.g., the first threshold and the second threshold) in order to keep the mobile device from continually changing advertising intervals as the ambient temperature momentarily reaches a switch point but drops below or goes above before reversing direction. For example, the temperature drops to 0 C for a few seconds then goes back above 0 C. Using a hysteresis effect or function, the mobile device may be prevented from changing the advertising interval back and forth due to momentary fluctuations in the ambient temperature. In one example, the temperature may be monitored so that the temperature must fall below the first threshold (e.g., 0 C) for more than 10 seconds before the mobile device will switch the advertising interval from the first interval to the second interval. In another example, the hysteresis effect may be implemented by requiring more than crossing the temperature threshold by a fraction of a degree such that the mobile device may be programmed to go from the first interval to the second interval at the first threshold of 0 C. Once it is in the second interval advertising rate it will not switch back to the first interval until the temperature rises above 1 C (or some other temperature high enough above 0 C to prevent continuous switching). This would ensure that the mobile device Twill not continuously be changing advertising intervals if there is some noise on the temperature sensor reading and the temperature is hovering around the first or second threshold. The time or temperature ranges for the hysteresis effect may be programmable for a desired lag/range.

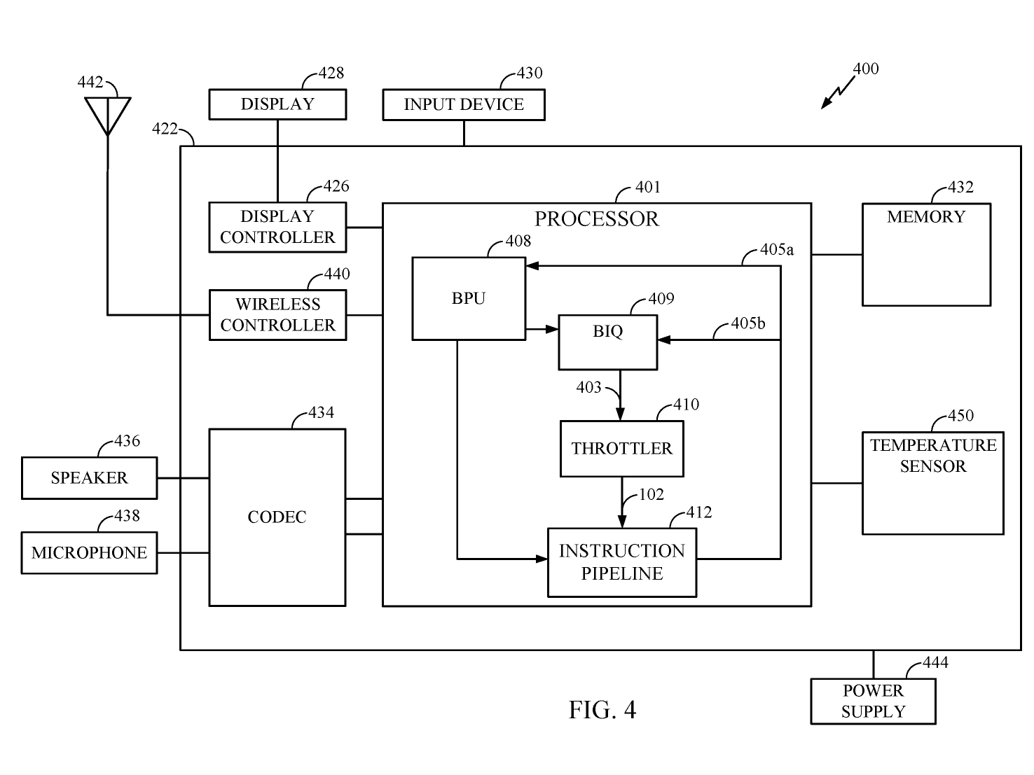

FIG. 4 illustrates an exemplary mobile device in accordance with some examples of the disclosure. Referring now to FIG. 4, a block diagram of a mobile device (e.g., first mobile device 100 and integrated device 500) that is configured according to exemplary aspects is depicted and generally designated 400. In some aspects, mobile device 400 may be configured as a wireless communication device. As shown, mobile device 400 includes processor 401, which may be configured to implement the methods described herein in some aspects, and a temperature sensor 450 (e.g., temperature sensor 110). Processor 401 is shown to comprise instruction pipeline 412, buffer processing unit (BPU) 408, branch instruction queue (BIQ) 409, and throttler 410 as is well-known in the art. Processor 401 may be a BLE enabled microcontroller, for example. Other well-known details (e.g., counters, entries, confidence fields, weighted sum, comparator, etc.) of these blocks have been omitted from this view of processor 401 for the sake of clarity.

Processor 401 may be communicatively coupled to memory 432. Mobile device 400 also include display 428 and display controller 426, with display controller 426 coupled to processor 401 and to display 428.

In some aspects, FIG. 4 may include coder/decoder (CODEC) 434 (e.g., an audio and/or voice CODEC) coupled to processor 401; speaker 436 and microphone 438 coupled to CODEC 434; and wireless controller 440 (which may include a modem) coupled to wireless antenna 442 (e.g., antenna 120) and to processor 401.

In a particular aspect, where one or more of the above-mentioned blocks are present, processor 401, display controller 426, memory 432, CODEC 434, and wireless controller 440 can be included in a system-in-package or system-on-chip device 422. Input device 430 (e.g., physical or virtual keyboard), power supply 444 (e.g., battery), display 428, input device 430, speaker 436, microphone 438, wireless antenna 442, and power supply 444 may be external to system-on-chip device 422 and may be coupled to a component of system-on-chip device 422, such as an interface or a controller.

It should be noted that although FIG. 4 depicts a mobile device, processor 401 and memory 432 may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

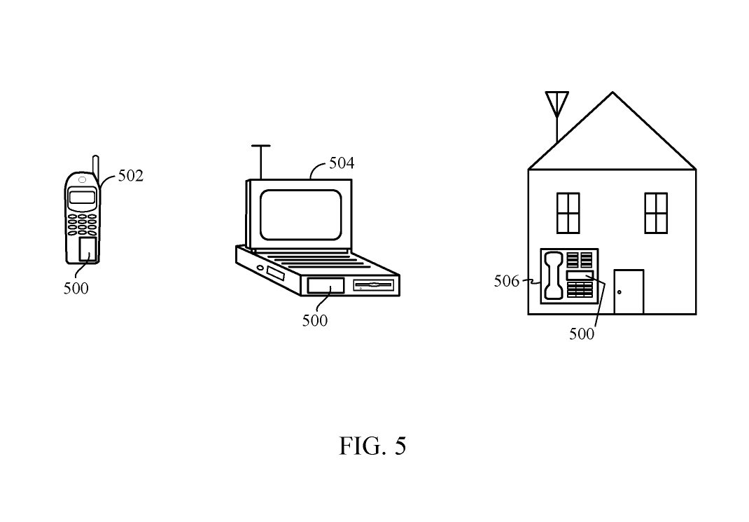

FIG. 5 illustrates various electronic devices that may be integrated with any of the aforementioned devices in accordance with some examples of the disclosure. For example, a mobile phone device 502, a laptop computer device 504, and a fixed location terminal device 506 may include an integrated device 500 as described herein. The integrated device 500 (e.g., first mobile device 100 and mobile device 400) may be, for example, any of the integrated circuits, dies, integrated devices, integrated device packages, integrated circuit devices, device packages, integrated circuit (IC) packages, package-on-package devices described herein. The devices 502, 504, 506 illustrated in FIG. 5 are merely exemplary. Other electronic devices may also feature the integrated device 500 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

It will be appreciated that various aspects disclosed herein can be described as functional equivalents to the structures, materials and/or devices described and/or recognized by those skilled in the art. For example, in one aspect, an apparatus may comprise a means for communicating (see, e.g., 100 in FIG. 1, 400 in FIG. 4, and 500 in FIG. 5), a means for setting an advertising interval (see, e.g., 100 in FIG. 1, 400 in FIG. 4 or 401 in FIG. 4, and 500 in FIG. 5), means for transmitting an advertising packet (see, e.g., 100 in FIG. 1 or 120 in FIG. 1, 400 in FIG. 4 or 442 in FIG. 4, and 500 in FIG. 5), and means for monitoring a temperature (see, e.g., 100 in FIG. 1 or 110 in FIG. 1, 400 in FIG. 4 or 450 in FIG. 4, and 500 in FIG. 5). It will be appreciated that the aforementioned aspects are merely provided as examples and the various aspects claimed are not limited to the specific references and/or illustrations cited as examples.

One or more of the components, processes, features, and/or functions illustrated in FIGS. 1-5 may be rearranged and/or combined into a single component, process, feature or function or incorporated in several components, processes, or functions. Additional elements, components, processes, and/or functions may also be added without departing from the disclosure. It should also be noted that FIGS. 1-5 and its corresponding description in the present disclosure is not limited to dies and/or ICs. In some implementations, FIGS. 1-5 and its corresponding description may be used to manufacture, create, provide, and/or produce integrated devices. In some implementations, a device may include a die, an integrated device, a die package, an integrated circuit (IC), a device package, an integrated circuit (IC) package, a wafer, a semiconductor device, a package on package (PoP) device, and/or an interposer.

In this description, certain terminology is used to describe certain features. The term “mobile device” can describe, and is not limited to, a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). Further, the terms “user equipment” (UE), “mobile terminal,” “mobile device,” and “wireless device,” can be interchangeable.

The wireless communication between electronic devices can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE), Bluetooth (BT), Bluetooth Low Energy (BLE) or other protocols that may be used in a wireless communications network or a data communications network. Bluetooth Low Energy (also known as Bluetooth LE, BLE, and Bluetooth Smart) is a wireless personal area network technology designed and marketed by the Bluetooth Special Interest Group intended to provide considerably reduced power consumption and cost while maintaining a similar communication range. BLE was merged into the main Bluetooth standard in 2010 with the adoption of the Bluetooth Core Specification Version 4.2 and updated in Bluetooth 5 (both expressly incorporated herein in their entirety).

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be incorporated entirely within any form of computer-readable storage medium having stored therein a corresponding set of computer instructions that upon execution would cause an associated processor to perform the functionality described herein. Thus, the various aspects of the disclosure may be incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art including non-transitory types of memory or storage mediums. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that—although a dependent claim can refer in the claims to a specific combination with one or a plurality of claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions of this method.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A method for varying an advertising interval, comprising:
initializing a mobile device configured to use a Bluetooth protocol for communication;
setting an advertising interval to a first interval, the advertising interval configured to set a time period for transmitting an advertising packet;
periodically transmitting the advertising packet at the first interval;
monitoring a temperature, by a temperature sensor, of an environment surrounding the mobile device;
setting the advertising interval to a second interval when the temperature reaches a first threshold or lower; and
transmitting the advertising packet at the second interval.

2. The method of claim 1, wherein the second interval is longer than the first interval.

3. The method of claim 1, wherein the first threshold is 0 C.

4. The method of claim 1, wherein the first interval comprising a fixed delay of approximately 10 millisecond to 10.24 seconds plus a random delay of approximately 0 milliseconds to 10 milliseconds.

5. The method of claim 1, wherein the Bluetooth protocol is a Bluetooth Low Energy protocol.

6. The method of claim 1, further comprising setting the advertising interval to a third interval when the temperature reaches a second threshold or lower.

7. The method of claim 6, wherein the third interval is longer than the second interval.

8. The method of claim 1, further comprising stopping transmission of the advertising packet and configuring the mobile device to operate in a low power state when the temperature reaches a second threshold or lower.

9. The method of claim 1, further comprising setting the advertising interval from the second interval to the first interval when the temperature exceeds the first threshold.

10. The method of claim 1, wherein the mobile device is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

11. A non-transitory computer-readable medium comprising instructions that when executed by a processor cause the processor to perform a method comprising:
initializing a mobile device configured to use a Bluetooth protocol for communication;
setting an advertising interval to a first interval, the advertising interval configured to set a time period for transmitting an advertising packet;
periodically transmitting the advertising packet at the first interval;
monitoring a temperature, by a temperature sensor, of an environment surrounding the mobile device;
setting the advertising interval to a second interval when the temperature reaches a first threshold or lower; and
transmitting the advertising packet at the second interval.

12. The non-transitory computer-readable medium of claim 11, wherein the second interval is longer than the first interval.

13. The non-transitory computer-readable medium of claim 11, wherein the first threshold is 0 C.

14. The non-transitory computer-readable medium of claim 11, wherein the first interval comprising a fixed delay of approximately 10 millisecond to 10.24 seconds plus a random delay of approximately 0 milliseconds to 10 milliseconds.

15. The non-transitory computer-readable medium of claim 11, wherein the Bluetooth protocol is a Bluetooth Low Energy protocol.

16. The non-transitory computer-readable medium of claim 11, the method further comprising setting the advertising interval to a third interval when the temperature reaches a second threshold or lower.

17. The non-transitory computer-readable medium of claim 16, wherein the third interval is longer than the second interval.

18. The non-transitory computer-readable medium of claim 11, the method further comprising stopping transmission of the advertising packet and configuring the mobile device to operate in a low power state when the temperature reaches a second threshold or lower.

19. The non-transitory computer-readable medium of claim 11, the method further comprising setting the advertising interval from the second interval to the first interval when the temperature exceeds the first threshold.

20. The non-transitory computer-readable medium of claim 11, wherein the; non-transitory computer-readable medium is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

21. A mobile device comprising:
a memory;
a processor coupled to the memory;
a temperature sensor coupled to the processor;
the processor configured to:
initialize the mobile device, the mobile device configured to use a Bluetooth protocol for communication;
set an advertising interval to a first interval, the advertising interval configured to set a time period for transmitting an advertising packet;
periodically transmit the advertising packet at the first interval;
monitor a temperature, by the temperature sensor, of an environment surrounding the mobile device;
set the advertising interval to a second interval when the temperature reaches a first threshold or lower; and
transmit the advertising packet at the second interval.

22. The mobile device of claim 21, wherein the second interval is longer than the first interval.

23. The mobile device of claim 21, wherein the first threshold is 0 C.

24. The mobile device of claim 21, wherein the first interval comprising a fixed delay of approximately 10 millisecond to 10.24 seconds plus a random delay of approximately 0 milliseconds to 10 milliseconds.

25. The mobile device of claim 21, wherein the Bluetooth protocol is a Bluetooth Low Energy protocol.

26. The mobile device of claim 21, wherein the processor is further configured to set the advertising interval to a third interval when the temperature reaches a second threshold or lower.

27. The mobile device of claim 26, wherein the third interval is longer than the second interval.

28. The mobile device of claim 21, wherein the processor is further configured to stop transmission of the advertising packet and configure the mobile device to operate in a low power state when the temperature reaches a second threshold or lower.

29. The mobile device of claim 21, wherein the processor is further configured to set the advertising interval from the second interval to the first interval when the temperature exceeds the first threshold.

30. The mobile device of claim 21, wherein the mobile device is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.
